(19) United States
(12) Patent Application Publication
(10) Pub. No.: US 2006/0179064 A1
(43) Pub. Date: Aug. 10, 2006

(54) Upgrading performance using aggregated information shared between management systems

(75) Inventors: Tomer Paz, Tel Aviv (IL); Yoel Goldenberg, Ramat Hasharon (IL)

Correspondence Address: Mavis S. Gallenson, Esq.;c/o LADAS & PARRY, Suite 2100, 5670 Wilshire Boulevard, Los Angeles, CA, 90036-5679, US

(73) Assignee: Nice Systems Ltd.

(21) Appl. No.: 11/350,297

(22) Filed: Feb. 7, 2006

Related U.S. Application Data
(60) Provisional application No. 60/649,916, filed on Feb. 7, 2005.

(51) Int. Cl. G06F 7/00

(52) U.S. Cl. 707/10

(57) ABSTRACT

A method of sharing information between computerized systems in an organization, including, collecting information from multiple computerized systems used by an organization, analyzing the collected information to derive new information based on the collected information, feeding the new information to more than one of the multiple computerized systems, utilizing the new information to affect the function of the computerized system to which it was fed, wherein the collecting and the feeding is performed on more than one type of computer based management systems.

### RELATED APPLICATIONS

The present application claims priority from U.S. provisional patent application No. 60/649,916 filed on Feb. 7, 2005, titled “UPGRADING PERFORMANCE USING AGGREGATED INFORMATION SHARED BETWEEN MANAGEMENT SYSTEMS”.

### FIELD OF INVENTION

The following invention relates to Business Performance Management, Workforce Management Systems, Business Intelligence, Business Information Systems, Customer Experience Management, Analytical customer relationship management (CRM), Intelligence Content Mining and Quality Management Systems.

### BACKGROUND OF THE INVENTION

Many service providers, providing services to customers such as provided by Contact Centers and Financial Institutions, use several distinct management systems such as transactional systems, quality management systems, computer telephony integration systems (CTI), content based interaction management systems and workforce management systems. The information gathered by the aggregations of all these management systems is usually exploited through the use of advanced data mining tools in systems that provide business intelligence, business analytics, performance analytics or for the provision of mere statistical data.

Each of these management systems is explicitly built to answer a market requirement. Non limiting examples are: Quality management in contact centers emerging from the need to evaluate the performance (e.g. quality of service) of the agents. Workforce management systems were built to answer the need for managing human resources efficiently for cost reduction. Content-based interaction management systems have emerged from a market request for gathering info during a multimedia session between an agent and a customer, whether it is audio based, VoIP based, video based, web browser based, message based or any other kind of interaction. Another name for content-based interaction management systems is customer experience management (CEM).

The drawback of the coexisting management systems is that they are managed alongside each other without fertilizing each other with information that would be beneficial to at least one of the management system, in particular enriching inherent core capabilities yielding higher performance for the benefit of the organization/enterprise. Furthermore, in order to provide better customer service there is a constant need for reducing bottlenecks, reducing the queue time, assigning “the right” agent, best fitting an agent to the customer and the like. To satisfy this need a new approach should be presented in which each of the management systems contribute knowledge and acquire feedback, recursively updating its knowledge database. Hence, what is missing from the prior art is the symbiosis or the aggregation of information drawn by one system to the benefit of the other and visa versa and all in all to the benefit of the organization.

The present invention relates to the descriptions in the following applications the disclosures of which are incorporated herein by reference:
1. U.S. patent application Ser. No. 10/484,107 titled METHOD, APPARATUS AND SYSTEM FOR CAPTURING AND ANLYSING INTERACTION BASED CONTENT, filed 18 Jul. 2002.
2. PCT application number PCT\L\0300300 titled APPARATUS, SYSTEM AND METHOD FOR DISPUTE RESOLUTION, REGULATION COMPLIANCE AND QUALITY MANAGEMENT IN FINANCIAL INSTITUTIONS, filed 9 Apr. 2003.
3. U.S. patent application Ser. No. 10/362,096 titled SYSTEM AND METHOD FOR CAPTURING BROWSER SESSIONS AND USER ACTIONS, filed 24 Aug. 2001.
4. U.S. patent application Ser. No. 10/469,550 titled SYSTEM AND METHOD FOR CAPTURING, ANALYSING AND RECORDING SCREEN EVENTS, filed 12 Mar. 2001.
5. U.S. patent application Ser. No. 09/503,459 titled TELEPHONE CALL MONITORING SYSTEM filed Feb. 14, 2000, now granted patent U.S. Pat. No. 6,542,602.

### SUMMARY OF THE INVENTION

The present invention provides a method and a system that takes coexisting management systems and uses the results drawn by each of the management system's inherent capabilities to the benefit of the others. The system takes the output of each of these systems, for example the score given to an agent using the evaluation done with a quality management system, combined with the output of an emotion detection algorithm on audio (which is a content-based interaction management engine that is activated on the interaction), is fed into a workforce management system to produce an improved skill-based workforce management system. An agent with high scoring (e.g. a supervisor gave him a high score in the evaluation form), the agent emotion level detected during his past interactions with customers together with the results produced from a word/sentence spotting engine indicating politeness and speech adherence, and maybe more information drawn from the CRM database and the agent's eLearning scored results, all would indicate agent skill level. The aggregation of this gathered knowledge is provided as an input into the workforce management thereby enriching the workforce management database with new information on the agent skills. A by product from this update allows, the workforce management system to use this input as to better match its agents to projects. An example of such a use is to match the most skilful agents to handle an important project by taking into account the existing agent profile together with constant updates of his/her performance monitored by other management systems.

Additionally, consider the benefit of a feedback coming from the workforce management system to the QM system giving feedback regarding the performance of a “skilful agent” during a campaign. This feedback should influence the scores assign to the agent by the QM system. Based on the feedback it can be determined if the agent needs more training, more monitoring of his interactions and/or if the agent lacks the skill to present commodities of specific types such that the campaign is affected.

The solution further presents the use of QM results together with both content-based analysis information and work force management (WFM) system information, which together provide information relating to an agent's skills. The aggregated information coming from the QM system, content based analysis and WFM can be used for skill based routing of calls, thus upgrading the efficiency of a call center, for example, the routing of calls for a specific dialer will be done according to the available agents skills and not only on availability basis as done today. In the present solution the call center is provided with information regarding each of the agents to intelligently distribute calls.

A call center strives to maximize the use and productivity of its agents. Systems known in the art give priority to a specific campaign where the best agents are grouped together to provide high performance.

In cases where a specific number (e.g. vector directory number (VDN)) is dedicated to a specific campaign, usually an automatic call distribution system (ACD) is programmed to find an available agent from a specific group to handle a call, for example the first agent to become free. Typically a call pending in the ACD queue is managed as in a first in first out (FIFO) buffer. Our solution is aimed for a smart ACD's predictive dialer, which can be configured to operate with compliance to the need for skill based routing, so as to receive inputs on agent's skills and while operating, distribute calls nonrandom as to give more incoming calls to the higher skilled agents (agent with higher productivity) thereby reducing the waiting time for a customer, and higher performance for the organization.

The aggregating of information generated by one management system whether it is computer telephony integration system (CTI) based information, content based derived information, workforce management information and the like, “digested” for the benefit of the other coexisting management system to produce higher performance of the receiving one and by virtue contributing to the overall performance of the organization/enterprise. Further more the solution gives managers the tools to better evaluate agent capabilities, getting better insight analyzing all aggregated information coming from each and everyone of the management systems. This allows the mangers to reward agents according to their real performance.

In an exemplary embodiment of the invention, the solution presented herein describes a new concept that combines information aggregated from one management system and fed to the other management systems together with describing a feedback mechanism which improves the performance of each of the management systems, and of the overall performance of management systems to the benefit of both customers and the enterprise.

Although examples are given regarding Contact Centers it will be appreciated to note that the solution are equally applicable to financial institutions such as banks, trading floors, insurance companies and any other transaction based service providers. The solution provided applies to any service provider that is interested in achieving a higher business performance and to better utilize its workforce based on the aggregation of knowledge coming from management systems. As an example consider that QM done on a particular trader may influence the routing of calls to the trader or if a traders profile shows that in the past few weeks there is a constant decrease in closing transactions together with indication of change in his behavior to customers (e.g. wherein a word spotting engine has detected the use of dirty words and/or cross-talk/talk-over the clients speech indicating impatient behavior to customers). An organization may chose to make changes with respect to their traders based on their performance in order to prevent damage to the organization and in contrast maximize productivity. The organization might decide to change an agents schedule, to call in the compliance officer or to increase monitoring the traders activity and/or prevent important customers from being routed to the trader.

In an exemplary embodiment of the invention, the system uses information discovered by one management system (e.g. the quality management system, CTI information, workforce management and aggregations of their activities based on data mining capabilities) to address the work done by other management systems in the contact center (e.g., predictive dialers, queue management, agent training).The ability to aggregate the knowledge for intelligent automatic control of work, allows to function more intelligently and thus become productive at lower costs, improve quality of service and better handle resources.

There is thus provided in accordance with an exemplary embodiment of the invention a method of sharing information between computerized systems in an organization, including, collecting information from multiple computerized systems used by an organization, analyzing the collected information to derive new information based on the collected information, feeding the new information to more than one of the multiple computerized systems, utilizing said new information to affect the function of the computerized system to which it was fed, wherein the collecting and the feeding are performed on more than one of the following types of computer based management systems:

a. an agent quality management system;

b. a call flow analysis system;

c. a customer survey system;

d. an audio content based analysis system;

e. a content management system;

f. a knowledge based management system;

g. a workforce management system;

h. a performance based knowledge system;

i. a circuit switch management system;

j. a VoIP management system; or

k. a computer telephony integration system.

Optionally, the analyzing comprises applying organization specific rules to the collected information. In some embodiments of the invention, the computerized systems include four or more of the computer based management systems listed above. Optionally, at least one of the multiple computerized systems only provide information. In an exemplary embodiment of the invention, at least one of the multiple computerized systems only receives information.

There is thus further provided according to an exemplary embodiment of the invention, a control system for sharing information between computer systems in an organization, including, a computer connected to multiple computer systems used by an organization to serve as the control system, wherein the control system is adapted to accept information from the multiple computer systems related to their functionality, wherein the control system is adapted to analyze the accepted information to produce new information based on the analyzed information, wherein the control system is adapted to feed the new information to more than one of the multiple computerized systems, and wherein the computer systems include more than one of the following types of computer based management systems:

a. an agent quality management system;

b. a call flow analysis system;

c. a customer survey system;

d. an audio content based interaction management system;

e. a screen content based interaction management system;

f. a knowledge based management system;

g. a workforce management system;

h. a performance based knowledge system;

i. a circuit switch management system;

j. a VoIP management system; or

k. a computer telephony integration system.

### BRIEF DESCRIPTION OF THE DRAWINGS

The present invention will be understood and appreciated more fully from the following detailed description taken in conjunction with the drawings. Identical structures, elements or parts, which appear in more than one figure, are generally labeled with the same or similar number in all the figures in which they appear, wherein:

FIG. 1 is a block diagram illustrating a disclosed solution of an advanced contact center, in accordance with a exemplary embodiment of the invention; and

FIG. 2 is a block diagram showing the components of a control system performing information aggregation and information sharing, in accordance with an exemplary embodiment of the invention.

### DETAILED DESCRIPTION

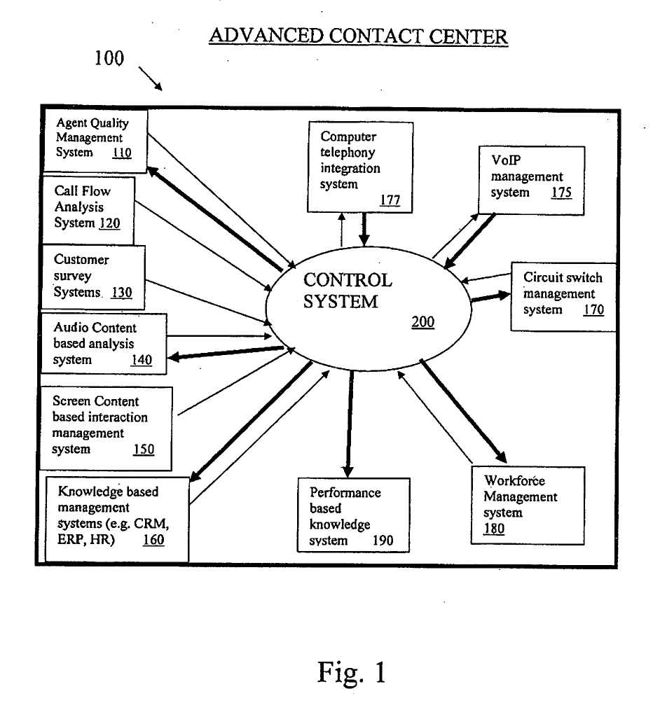

FIG. 1 is a block diagram illustrating a disclosed solution of an advanced contact center 100, in accordance with a exemplary embodiment of the invention.

The present description introduces management systems of advanced contact center 100 as illustrated in FIG. 1, which are part of an overall solution according to an exemplary embodiment of the invention.

Agent quality management (QM) systems 110 are commonly used as a tool that enables supervisors to monitor an agents interactions using a set of predefined requirements. Typically an agents conversations with customers are recorded and a supervisor can review them to evaluate the quality of service. Examples of the usage of such a system are presented in U.S. Pat. No. 6,542,602 titled “TELEPHONE CALL MONITORING SYSTEM” filed Feb. 14 2000, and was incorporated above by reference. The results of this tool are used as a source of information for the invention described herein.

Workforce management systems 180 are commonly used as a tool that coordinates the deployment of agents and helps build their work-schedules. The agents schedules are being used as a source of information for our invention and our solution will feed new limitations using intelligence gathered from other coexisting source tools that form the system described herein.

Customer survey/feedback systems 130 are commonly used as a tool for managing surveys to accept feedback from the customers regarding their satisfaction or dis-satisfaction with the provided service. A customer feedback system typically incorporates an integrated voice response (IVR) system to collect response from the customers, for example performing an automatic post-call survey (e.g. the customer is asked to answer several questions related to their experience with the agent). In an exemplary embodiment of the invention, the results of this tool are used as a source of information for the system described herein. Content-based interaction management systems are described in details in co-pending U.S. application Ser. No. 10/484,107 titled “METHOD, APPARATUS AND SYSTEM FOR CAPTURING AND ANALYSING INTERACTION BASED CONTENT” filed on Jul. 18, 2002 and in co-pending PCT patent application PCT\L03\00300 titled “APPARATUS, SYSTEM AND METHOD FOR DISPUTE RESOLUTION, REGULATION COMPLIANCE AND QUALITY MANAGEMENT IN FINANCIAL INSTITUTIONS”, filed Apr. 9, 2003, which were incorporated above by reference.

Content based analysis systems 140 concentrate on mining multimedia interaction for example audio content analysis analyzes the audio during (in real time) or after the interaction was terminated (offline) to detect specific words exchanged during the interaction (through word spotting or transcription technologies). Content based analysis systems also check for emotion signs (e.g. positive vs. negative emotions such as stress or laughter etc.) during the conversation between parties, and whether there are periods where the agent or the customer were speaking at the same time (cross talk/talk over) or if there are long periods of silence during the conversation, and the like. Mining the results of the content based analysis and further managing it using classification and categorization algorithms produces knowledge about Customer-Agent experience and updating their respective profiles. In an exemplary embodiment of the invention, the results of content based analysis systems tool are used as a source of information for the system described herein.

Content Management Systems 150, which are referred to as screen sensing or screen based content analysis systems are an example of systems or methods which are used to analyze an agents activities on the screen (e.g. an agents interaction with a computer). Information drawn using this “spy” techniques gives indication on the agent skills, and understanding in utilizing computerized applications provided by the organization for the benefit of customers. Any information typed by the agent into input fields on any of the organization workstations is recorded and further analyzed either for example for compliance to regulation in financial institutions or for QM in contact centers. As an example an agent that performs a lot of backspacing, multiple deletions, going forward and backward between screens may indicate the agent is not familiar with the applications. More detailed examples can be found in co-pending U.S. application Ser. No. 10/362,096, titled “SYSTEM AND METHOD FOR CAPTURING BROWSER SESSIONS AND USER ACTIONS” filed Aug. 24 2001, and in U.S. application Ser. No. 10/469,550 SYSTEM AND METHOD FOR CAPTURING, ANALYSING AND RECORDING SCREEN EVENTS filed 12 Mar. 2001, the disclosure of which were incorporated above by reference. In an exemplary embodiment of the invention, the capturing management system can be defined selectively thus setting pre-defined rules as to which applications or fields of an application to record. Alternatively, the entire screen is sensed and all applications or information entered into the display fields are recorded and analyzed. In an exemplary embodiment of the invention, the results of this tool are used as a source of information for the system described herein.

Knowledge based management systems 160 provide rules for managing an organizational service, for example a computer telephony integration system (CTI) 177, a circuit switch management system 170 based on a smart automatic call distribution (ACD) service or a VoIP management system 175. Knowledge based management system 160 provides customer relationship management (CRM) information resulting from call flow analysis based on the conversations with the customers. This information can be used in order to enhance the organization management models. The parameters monitored typically include: call duration, number of call holds, hold duration, number of call transfers, automatic number identification (ANI), dialed number identification service (DNIS), time of day of the call and other parameters. Knowledge based management system 160 provides the rules for call distribution, for example based on agent skill or the language used by the caller/agent.

Other types of systems may also be managed by knowledge based management system 160, for example enterprise resource planning (ERP) systems and human resource management systems (HR). ERP systems typically deal with planning, manufacturing, sales and marketing in a business. An ERP system typically controls inventory, order tracking, customer service and other aspects of the business. HR systems typically control human resources for example dealing with administration, payroll, recruiting, training and worker performance.

In an exemplary embodiment of the invention, the proposed system comprises a control center 200 which is based on the concept of working in a continuous loop of three phases:

1. The Collection stage where knowledge information is gathered from several sources.

2. The Analysis stage where analysis is performed on the collected information (over a pre-defined length of time which can be adjusted based on the need) to derive values (new metadata) and perform follow up actions.

3. The Feed stage where different management systems and/or components of that systems are fed with the results of the analysis stage.

In some embodiments of the invention, a feedback stage is also provided wherein the management systems provides results from the analysis stage as feedback regarding the performance to the data sources. Optionally, after the aggregated information finished a cycle, the process will start again. The timings of a cycle vary according to the business needs, environmental factors and can vary according to the different recipients.

The following is a detailed description of the stages followed with examples. In the Collection Phase, information is collected from at least one of the various participating sources. Information such as the Quality of service ratings the agents' interactions is taken from the agent QM system 110 together with Customer feedback taken from the customer feedback system 130 (e.g. from a survey management system). The two pieces of information gathered may serve to indicate for example how well the agent treated the customer. Another non-limiting example is information collected from the content-based analysis system. Commonly many contact center systems provide information to a performance based knowledge system 190 to provide feedback to the client regarding the performance of the systems. Optionally, in the proposed solution control center 200 will accept the performance data and be able to provide performance data regarding all of advanced contact center 100.

The following are examples of engines and some of their respective derived knowledge:

A word spotting engine searches for specific words. An emotion detection engine tuned for monitoring the emotion levels detects the presence of negative/positive emotion segments within the interaction, (e.g. agent shouting or customer stressed, agent laughter etc.). A Talk analysis engine searches for periods in which both the agent and the customer were speaking together (speech overlap (talk over)). Optionally, the amount of talk over gives indication on how well the interaction between the customer and agent was. Another example of talk analysis is an engine identifying long periods of silence during the conversation. Another example of an engine is a speaker identification system; it matches a stored speaker's speech sample with a speaker participating in the interaction to determine what percentage of the conversation was controlled by the agent.

In an exemplary embodiment of the invention, workforce management system 180 provides information regarding the different types of workers (e.g. contact center agents, stock exchange traders etc.), what skills they posses and their respective schedules. Additionally, workforce management system 180 can also provide a list of the available tasks and the skills required for each task (e.g. what experience is required).

In an exemplary embodiment of the invention, screen content analysis serves as another source for collecting information regarding the agents by analyzing the agents interactions with the application on his/her workstation. The content analysis tool records all the actions occurring on the screen, for example: clicking on specific buttons, opening new windows, closing windows, entering information in prescribed locations, mouse clicks, mouse movements and the like. Optionally, information can be deduced on the skill of agents in operating the software application tools used by them while serving the customer for example on the phone. A call flow analysis system 120 follows customer interaction call flow (e.g. CTI information, Queue/routing information, statistical ACD's, content management system (CMS) information etc.).

In an exemplary embodiment of the invention, knowledge based management system 160 may supply telephony interaction data, (e.g. traditional and non-Traditional, IP and non-IP) based information. Types of such information may include: hold events, ring events, hang up (on hook) signaling events, number of transfers (transferred calls), conference call, queue time, etc. In an exemplary embodiment of the invention, a statistical automatic call delivery (ACD) system may provide details regarding the number of times a customer was put on hold, which can be used to infer regarding an agents skill in handling calls. Additionally, the number of call transfers may imply that call routing is done inefficiently. The information regarding the rules for skill based routing of calls can be provided by an ACD. Optionally, this information also reflects regarding the different types of agents in advanced contact center 100 and their respective skills.

In an exemplary embodiment of the invention, knowledge based management system 160 serves as another source from which data is constantly collected. Such systems typically serve as the organizations administrative/operational core systems (e.g. CRM, ERP, HR). These systems hold a myriad of information regarding profile of customers (e.g. VIP, etc.), transactional information, organization regulations, flow of information, process alignments, etc. Optionally, all this information is gathered/collected and used for the benefit of advanced contact center 100. One example of a benefit from the operation of advanced contact center 100 is the collection of business information regarding the identity of the organizations most valued customers. This information is provided as input to other systems of advanced contact center 100 to assure that the valued customers will receive preferential treatment, for example not be put on hold, and dealt with by a skilled agent.

In an exemplary embodiment of the invention, the analysis phase takes all the collected information, applying certain rules which use the collected information to achieve a set of results to be applied in the feed phase. These rules are not bound specifically to certain prescribed results but should be applied according to the specific needs of each organization. The results could include actions to be applied.

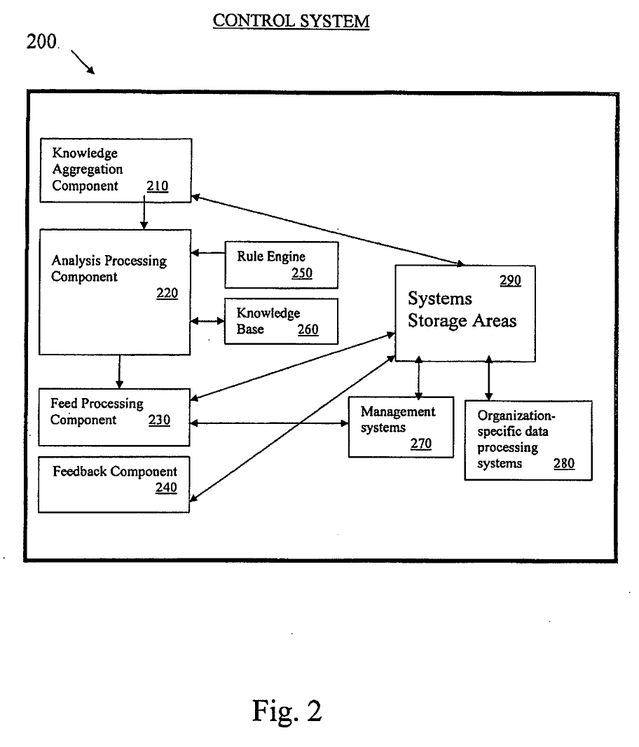

FIG. 2 is a block diagram showing the components of control system 200 performing information aggregation and information sharing, in accordance with an exemplary embodiment of the invention.

In an exemplary embodiment of the invention, control system 200 comprises a rule engine 250 that builds analysis rules and run them according to the specific issues which the specific organization wishes to tackle. In the present description we especially describe the use of control system 200 in advanced contact center 100, however it is equally applicable to any type of service providing organization.

In an exemplary embodiment of the invention, agents receiving low QM scores and/or bad feedback scores can be prevented from answering calls that originate from high value customers. Optionally, this rule is fed into workforce management system 180 and to the ACD, which is optionally controlled by knowledge base management system 160. In an exemplary embodiment of the invention, an agents quality score derived from the aggregation of information coming from several sources, for example: QM scores, feedback information, length of calls, average number of mouse clicks, number of backspace and delete and mouse distance (as a way to calculate competency), agent's and/or customer's emotion during conversations, agents adherence to verbal speech as dictated by the organization policy as verified by the audio analysis engine (e.g. a call should start with the sentence “good morning, Andrew speaking, how can I help you?”).

In an exemplary embodiment of the invention, different organizations may implement the acquired knowledge differently, for example using information collected on the agents, to affect agent assignment via workforce management 180 or to affect call division via knowledge based management system 160 or circuit switch management system 170. Optionally, information generated from the organization knowledge based management system 160 such as regarding customer profile and purchasing habits combined with information coming from another management system that produces information based on a customers past interactions can identify patterns of customer behavior (e.g. a customer that tends on a regular bases to become very emotional when the agent doesn't listen and barge in during the interaction, a customer that is very sensitive, a customer that is very impatient, a customer that is usually restless in his answers). Taking the information aggregated from two different management system, feeding it all into control system 200 may assure the assignment of an agent more suitable for a specific customer. Similarly, aggregated information about an agent's performance can help to take remedial actions, for example if an agent shows signs of insecurity, actions can automatically be generated such as alerting his supervisor to address the issue. Optionally, a supervisor may provide additional training (e.g. through elearning periods) or make sure that scheduling and queue assignments are updated to comply with the agents problems.

In an exemplary embodiment of the invention, advanced contact center 100 may provides services to multiple regions or countries and would need to take into account cultural implications, such as: language proficiency, speech adherence discrepancies, regulations and other cultural differences. In an exemplary embodiment of the invention, advanced contact center 100 will assign appropriate agents to deal the issues they are equipped to handle, for example an agent which is known for his/her long periods of silence should not be assigned to handle countries were customers expect the agents to be more talkative and fluent as often occurs in certain regions, or agent with past record of cross talk (talk over) will sound impolite serving one region as opposed to other region where it is kind of a custom to barge in during conversation. A further example of regional differences is the use of certain polite words as part of the language for example “would you please” (Very English) as opposed to using “can you please”. Furthermore since the aggregated information is coming from all the management systems, some which are very specific and some which are very wide in scope, data mining techniques would be employed to research specific issues, so that the results can be used by other parts of advanced contact center 100.

In an exemplary embodiment of the invention, information from workforce management system 180 regarding the specific utilization of an agent can be used by agent Quality Management system 110 to manage recordings of calls in a way that will evenly distribute the recordings amongst the various agents.

The Feed phase takes the results of the analysis phase and applies them to the process-oriented systems of the organization. In the field of reporting (follow up within the organization) this will aggregate gathered and analyzed information and distribute the relevant parts of it to specific key people within the organization.

In an exemplary embodiment of the invention, workforce management system 180 will be tuned to make sure that the right agents are assigned at the proper times according to the various rules which were originally written complying with the results of the analysis phase. This will improve greatly the results of the agent assignments as it will not only take into account shift information but can also rank agents by specific skills and assign them accordingly. For example, we may wish to have all high quality agents (those who get high quality scores) to be available in a specific shift or to be evenly distributed during the day. Optionally, use of interactions/transaction outcomes (purchase order submitted, problem/case status—resolved or not, new commodities were presented and the like) as can be found via a CRM system can be used as a basis to define agent quality and build schedules accordingly. The queues in the ACD, the skill based routing information and predictive dialers will be fed with results achieved from the analysis phase so that the queues will be built in a more productive way based on the rules the organization would like to employ. Deploying rules according to customer preferences for example assigning agents according to purchasing habit of customers for example by past recorded (mined) customer profile it was detected that the customer is found to purchase cosmetic related commodities so a highly knowledgeable agent in that field is assigned to the customer. The entire “raw” data collected and the analyzed information are fed either to the switch/ACD or to any other organization knowledge gathering database in the contact center, as evident today organization's knowledge base becomes more and more comprehensive to provide extra knowledge for better handling tasks. An example is the payroll system which can be fed with the agent quality information, work hours and overtime aggregated from the workforce management (or any other relevant piece of information that was presented herein) to form the basis for bonus pay. Also, the aggregated information from the different systems and the analysis results can feed performance based knowledge system 190, which is a KPI (key performance indicator) management tool that distributes these managerial indicators to the relevant managers.

Referring back to FIG. 2 control system 200 which performs information aggregation and information sharing operates in a computing environment which is associated with an enterprise organization. The computing environment includes computer-based process-oriented systems that operate therein. The system for combining and distributing information comprises a knowledge aggregation component 210 which is coupled to a specific storage area of the computer-based process-oriented systems and/or to a shared storage area 290. Knowledge aggregation component 210 is responsible for aggregating information from the computer-based process-oriented systems. Control system 200 further comprises an analysis processing component 220 coupled to knowledge aggregation component 210 and to a feed processing component 230. Analysis processing component 220 is responsible for receiving information from knowledge aggregation component 210, for applying organization-specific analysis rules to the received information and to provide derived results to feed processing component 230. Feed processing component 230 is coupled to the analysis processing component 220 and to computer-based management systems 270, which represents the management systems shown in FIG. 1. Feed processing component 230 is responsible for receiving derived results from analysis processing component 220 and to distribute the results to computer-based management systems 270 shown in FIG. 1. Analysis processing component 220 further comprises a rule engine 250 for building organization-specific analysis rules and for applying the rules in an organization--specific manner. Analysis processing component 220 further comprises an organization-specific knowledge base 260 configured in accordance with the characteristics of computer-based management systems 270 operating in the computing environment, and in accordance with customer preferences. Computer-based process-oriented systems 270 as shown in FIG. 1 could be running on multiple computer systems or on an organization-specific computer system which also runs organization specific data processing systems 280. The computer-based management systems could be Quality Management system 110 or workforce management system 180 or survey Management system 130 or other systems, for example as shown in FIG. 1. Advanced contact center 100 could be implemented by a standard contact center and/or a financial institution or a commercial institution or an industrial enterprise or an educational institution or the like. The aggregated information is multi-media information. The multi-media information can be VoIP information or audio information or video information, or messaging information or other types known in the art.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the invention. Further combinations of the above features are also considered to be within the scope of some embodiments of the invention.

Section headings are provided for assistance in navigation and should not be considered as necessarily limiting the contents of the section.

It will be appreciated by persons skilled in the art that the present invention is not limited to what has been particularly shown and described hereinabove. Rather the scope of the present invention is defined only by the claims, which follow.

1. A method of sharing information between computerized systems in an organization, comprising:
collecting information from multiple computerized systems used by an organization;
analyzing the collected information to derive new information based on the collected information;
feeding the new information to more than one of the multiple computerized systems;
utilizing said new information to affect the function of the computerized system to which it was fed; and
wherein said collecting and said feeding are performed on more than one of the following types of computer based management systems:
a. an agent quality management system;
b. a call flow analysis system;
c. a customer survey system;
d. an audio content based analysis system;
e. a content management system;
f. a knowledge based management system;
g. a workforce management system;
h. a performance based knowledge system;
i. a circuit switch management system;
j. a VoIP management system; or
k. a computer telephony integration system.

2. A method according to claim 1, wherein said analyzing comprises applying organization specific rules to the collected information.

3. A method according to claim 1, wherein said computerized systems include four or more of the computer based management systems listed in claim 1.

4. A method according to claim 1, wherein at least one of said multiple computerized systems only provide information.

5. A method according to claim 1, wherein, at least one of said multiple computerized systems only receives information.

6. A control system for sharing information between computer systems in an organization, comprising:
a computer connected to multiple computer systems used by an organization to serve as the control system;
wherein said control system is adapted to accept information from said multiple computer systems related to their functionality;
wherein said control system is adapted to analyze the accepted information to produce new information based on the analyzed information;
wherein said control system is adapted to feed the new information to more than one of the multiple computerized systems; and
wherein said computer systems include more than one of the following types of computer based management systems:
a. an agent quality management system;
b. a call flow analysis system;
c. a customer survey system;
d. an audio content based interaction management system;
e. a screen content based interaction management system;
f. a knowledge based management system;
g. a workforce management system;
h. a performance based knowledge system;
i. a circuit switch management system;
j. a VoIP management system; or
k. a computer telephony integration system.
